(19) United States
(12) Patent Application Publication
(10) Pub. No.: US 2014/0110953 A1
(43) Pub. Date: Apr. 24, 2014

(54) Horizontal latch operating system

(71) Applicants: Stéfane Leib, St. Charles Borromee (CA); Luc Rainville, St Gabriel De Brandon (CA)

(72) Inventors: Stéfane Leib, St. Charles Borromee (CA); Luc Rainville, St Gabriel De Brandon (CA)

(21) Appl. No.: 13/694,039

(22) Filed: Oct. 23, 2012

(51) Int. Cl. E05C 9/10

(52) U.S. Cl. CPC E05C 9/10
USPC 292/263

(57) ABSTRACT

The present invention provides a latch System for vehicles, equipment and other door open/close systems. The system comprises dual latch system operable horizontally thus making open/closure mechanism safe and secure. The Horizontal Latch System is activated by pistons or cylinders (pneumatic or hydraulic) and uses an approach that allows for the system to be operable at all times even if there is a problem with the cylinders or pistons. The System of present invention is unique because it offers a better and safer approach to the opening and closing of tailgates; adds longevity to the tailgate and reduces maintenance costs.

### FIELD OF THE INVENTION

The invention relates generally to the fields of latch system for vehicles, equipment and other door open/close systems.

More particularly, the invention relates to Horizontal Latch Systems.

The latch system of present invention can be operated either by pneumatically or hydraulically. A typical dump truck is equipped with a hydraulically operated open-box bed hinged at the rear, the front of which can be lifted up to allow the contents to be deposited on the ground behind the truck at the site of delivery.

### BACKGROUND OF THE INVENTION

A dump truck is a truck used for transporting loose material (such as sand, gravel or dirt) for construction or other purposes such as land fill, etc. but not limited to these activities.

A typical dump truck is equipped with a hydraulically operated open-box bed hinged at the rear, the front of which can be lifted up to allow the contents to be deposited on the ground behind the truck at the site of delivery. The hydraulically operated open-box has a front end, two side walls and a tailgate pivotally mounted to rear upper end portion of the open box.

A latching device is provided at the bottom end portion of the open-box. When the truck is loaded with some material, the latch firmly holds the tail gate, so as to not to allow unwanted material to fall out or empty unexpectedly, or during the transit.

Reference may be made to U.S. Pat. No. 4,029,357 by Bishop et al. This patent relates to ‘Strut extension lock for dump trucks’. In this invention, in a dump truck including a base supporting a dump bucket is provided, which is supported pivotally along one of its upper edges at the upper ends of vertically extending telescoping struts carried by the base. The power devices are connected to the top edge of the bucket in transversely spaced relation from its pivotal axis and operable to raise the bucket, whereby the bucket is first raised in a non-tilted position by extension of the struts, and then tilted to a dump position about its pivotal axis, the provision of a locking latch operable to secure the struts releasably in their extended positions, the latch being activated by movement of the bucket away from its horizontal position, and deactivated by the return of the bucket to its horizontal position. In combination with a dump truck including a wheeled bed, slidably extensible struts having a limit degree of extensibility fixed to said bed and extending upwardly there from. Each of said struts include two slidably telescoped sections, a dump bucket normally resting on said bed and pivoted along one of its upper edges on a horizontal axis to the upper ends of said struts, and power means operable to exert an upward force on said bucket intermediate the vertical planes of its pivotal axis and its center of gravity, whereby said bucket is first elevated in an upright position to the limit of the extensibility of said struts, and then tilted about its pivotal axis to a dump position wherein its weight causes a reversal of the tensile load on said struts to a compressive load, a strut extension lock operable to prevent retraction of said struts under said compressive load.

Further reference may be made to U.S. Pat. No. 4,176,881 by Cole, which relates to ‘Lock device for dump trucks’. In this invention, a self acting lock is provided which automatically locks down the dump body of a truck and automatically releases when the body is to be raised. Two pairs of lever arms which are pivoted together cooperate with a single acting hydraulic cylinder to provide a hoist for raising and lowering the dump body. The upper arms are pivoted to the body and the lower arms are pivoted to a pair of links which are in turn pivotally mounted to the truck frame.

Each link carries a hook which engages with a keeper rod carried on the upper pair of arms to lock down the body. A leg extending from the upper arms pivots the links in a direction to engage the hooks with the keeper rod in response to lowering of the dump body to the load carrying position. The linkage is arranged such that initial extension of the cylinder pivots the links in a direction to release the hooks from the rod before continued extension of the cylinder raises the dump body in the usual manner.

Another reference may be made to U.S. Pat. No. 5,299,856 by Grosz about ‘Dump vehicle with hydraulic lock for material holding container’. This invention relates to a dump vehicle, such as for agricultural use. The vehicle includes a movable support member and a slide structure for supporting and guiding the support member, a container pivotally mounted to the support member, a hydraulic actuator mechanism actuable to lift the container from an original lowered position to a predetermined raised position and to tilt the container at the support member when in the predetermined raised position to a preselected tilted position to permit discharge of the contents of the container. The dump vehicle further includes a hydraulic lock mechanism actuable in response to tilting of the container towards the tilted position to lock the support member in the predetermined raised position to prevent over centering and downward movement of the container from the predetermined raised position during tilting and discharging of the container. The hydraulic lock mechanism is responsive to the container returning to its pretilted position while at the predetermined raised position to unlock the support member and to permit return of the container to its original lowered position.

Reference may also be made to U.S. Pat. No. 5,362,184 by Hull, et al. This invention is about a ‘Lock device for garbage truck container’. In this invention, a locking device is disclosed which is adapted to be welded to at least two support rails of the bed of a truck such as a garbage truck and which engages the I-beams of the container such as a garbage container to eliminate the necessity of chaining the container to the garbage truck, thus saving time and providing safety from snapping a chain.

U.S. Pat. No. 6,137,419 to Lennox et al. discloses a pickup truck tailgate monitor. In Lennox, a tailgate monitor in an operator's compartment of a pickup warns the operator if the tailgate is open. Safety is the goal of this patent.

U.S. Pat. No. 7,591,513 to Moreley discloses a system for controlling a dump truck's tailgate opening, when dumping materials out in piles or spreading. The system has a mechanically controlled device that can be mounted to a conventional dump box.

A connecting arm is attached to a tailgate which interconnects with a control unit mounted on the dump box.

The control unit is configured to catch the tailgate as it falls from a closed position due to the force of gravity. The system allows an operator to select, from within the truck's cab, one or more opening positions for the tailgate. This patent's purpose is for convenience of usage not a horizontal latch system.

U.S. Pat. Appl. No. 20070296226 to Magna International Co. discloses a latch device with pivot cam mechanism for securing latch for rotation and support the door of a vehicle.

U.S. Pat. Application No 20110025117 to Williams discloses a universal tailgate assembly for a truck dump having adjustable features that can be used for various dump truck body sizes and shapes.

U.S. Pat. No. 6,753,787 to Cole device for alerting the operator of a truck equipped with a dump bed when the tailgate is unsecured.

However, these latch systems are directly visible and often have contact with the debris. Therefore, they are less reliable and expensive maintenance is required. These latch systems further use vertical processes for tailgate open/close mechanisms instead of the horizontal process making it more complex. Therefore, there is a need for a more reliable latch system which can be hidden from the view and the debris.

### SUMMARY OF THE INVENTION

Thus, it is an object of the present invention to provide a Horizontal Latch System.

Further, it is another object of the present invention to provide a better latch system for vehicles and equipment and other door open systems that hides the Latch System from the debris.

It is another object of the present invention to provide a latch system which is operable both pneumatically and hydraulically as and when required.

It is a further object of the present invention to provide a latch system which is functional even if both hydraulic and pneumatic systems fail to work in any circumstance.

### DESCRIPTION OF THE DRAWINGS

The present invention will be readily understood by the following detailed description in conjunction with the enclosed drawings, wherein like reference numerals designate like structural elements, and in which:

FIG. 1 illustrates a top view of the Horizontal Latch System comprising a dual latch system extending perpendicular to the central axis of the cylinder rod 2. Both the latches are connected to the cylinder rod 2 by center link.

FIG. 2 Illustrates an Isometric view of the Horizontal Latch System.

### DETAILED DESCRIPTION OF THE ILLUSTRATED EMBODIMENTS

NOTE: The following is the preferred embodiment or best mode for carrying out the invention. It should be noted that this invention is not limited by the discussion of the preferred embodiment.

Embodiments of the present invention will be described below with reference to the enclosed drawings.

In one embodiment, the Horizontal Latch System is composed of two latches that close on pins installed under the door, making certain the closure is safe and secure.

The horizontal latch system is activated by pistons or cylinders (pneumatic or hydraulic) and uses a mechanical approach allowing the system to be operable even if there is a problem with the hydraulic or pneumatic cylinders or pistons.

The system of present invention comprises a cylinder rod (2) which is also defined as ‘moving component’ throughout the specification and claims; this component is contained by a cylinder (3). The cylinder (3) is connected to a cylinder bracket (1) by a clevis pin (2).

As the cylinder rod (2) moves along its central axis, the axial movement is transformed into horizontal movement by the central pivot arm (14) and yoke left hand thread (7) by pivoting along their respective pivot joints. The horizontal motion created by the central pivot arm (14) and yoke left hand thread (7) is transferred to the yoke (10) by the side link (8) and thread rod (9). The locking jaw (11) and the yoke are pivotally connected and the locking jaw (11) is hinged to a supporting plate by a retaining washer (12) for transforming the axial motion of the yoke into rotational motion, so that the locking jaw (11) firmly gets locked.

The cylinder rod (2) is activated by pistons or cylinders (pneumatic or hydraulic) and also uses an approach allowing the system to be operable even if there is a problem with the cylinders or the pistons actuated hydraulically or pneumatically. The horizontal latch operating system can be used for dump trucks or other vehicles but not limited to the usage of these vehicles.

The horizontal latch operating system can be operated by hydraulic and pneumatic pistons or cylinders. The latches are completely hidden from view or contact which avoids unnecessary damages or contact with the material being unloaded, making the system completely safe and hazard free. The horizontal latch operating system can be oiled or greased allowing for a smooth operation and a long life as pivot points and other areas are easily accessible. The horizontal latch operating system is adjustable and can be used for various applications irrespective of size variations. The operating system and closing are secured by controlling the movement which does not allow or permit any uncontrolled or undesired opening and closing of the system.

The embodiments described herein are examples of structures, systems or methods having elements corresponding to the elements of the invention recited in the claims. This written description may enable those skilled in the art to make and use embodiments having alternative elements that likewise correspond to the elements of the invention recited in the claims.

The intended scope of the invention thus includes other structures, systems or methods that do not differ from the literal language of the claims, and further includes other structures, systems or methods with insubstantial differences from the literal language of the claims.

The horizontal latch operating system of the present invention is such that it can be operated by hydraulic or by pneumatic pistons or cylinders. However, the system is able to operate even if any of these systems fail to work for some reason.

The horizontal latch operating system can be used for dump trucks or other vehicles but not limited to the usage of these vehicles.

The latches are completely hidden from view or contact with material inside the vehicle, which avoids unnecessary damages or contact with the material being unloaded, thus making the system completely safe and hazard free. The horizontal latch operating system can be oiled or greased allowing for a smooth operation and a long life as pivot points and other areas are easily accessible. The horizontal latch operating system is adjustable and can be used for various applications irrespective of size variations. The operating system and closing mechanism are secured by controlling the movement that does not allow or permit any uncontrolled or undesired opening and closing of the system.

The Horizontal Latch System is composed of two latches that close on pins installed under the door, making certain the closure is safe and secure. Because the tailgate doors or dump truck doors open horizontally, the latch system is protected from debris or material that is unloaded from the vehicle. This enables the latch system to last longer and use less maintenance.

The horizontal latch system is activated by pistons or cylinders (pneumatic or hydraulic) and uses a mechanical approach allowing the system to be operable even if there is a problem with the hydraulic or pneumatic cylinders or pistons.

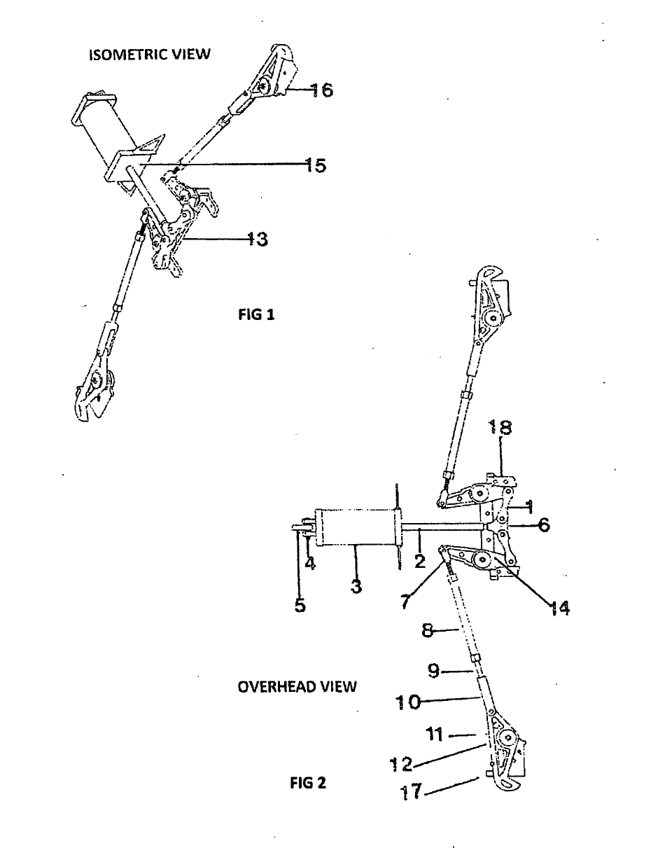

FIG. 1 illustrates a top view of the Horizontal Latch System comprising a dual latch system extending perpendicular to the central axis of the cylinder rod (2). Both the latches are connected to the cylinder rod (2) by center link.

The cylinder rod (2) is a moving component that is contained by a cylinder (3). Further the cylinder (3) is connected to a cylinder bracket (5) by a clevis pin (2). As the cylinder rod (2) moves along its central axis, the axial movement is transformed into horizontal movement by the central pivot arm (14) and yoke left hand thread (7) by pivoting along their respective pivot joints.

The horizontal motion created by the central pivot arm (14) and yoke left hand thread (7) is transferred to the yoke (10) by the side link (8) and thread rod (9).

The locking jaw (11) and the yoke are pivotally connected and the locking jaw (13.) is hinged to a supporting plate by a retaining washer (12) for transforming the axial motion of the yoke into rotational motion, so that the locking jaw (11) firmly gets locked. The cylinder rod (2) is activated by pistons or cylinders (pneumatic or hydraulic) and also uses an approach allowing the system to be operable even if there is a problem with the cylinders or the pistons actuated hydraulically or pneumatically.

Accordingly, the present invention provides a system for operating the door locking and unlocking mechanism in a vehicle or box, said system comprising a pair of latches extending towards opposite sides, a central assembly plate (13) and an external assembly plate (16); said central assembly plate (13) is having a central latch stopper (18) and a central pivotal arm (14) attached; said central assembly plate (13) is further attached to a cylinder alignment plate (15) by means of a cylindrical rod (2) in a cylindrical casing (3) having a clevis pin (4) in the cylindrical bracket (5); said external assembly plate (16) is having an external latch stopper (17) along with a locking jaw (11) and a retaining washer (12), wherein said central plate (13) and external plate (16) are connected by means of a side link (8) having a threaded rod (9) and a yoke (10); the said pair of latches being operable simultaneously in horizontal direction and the entire system being operated in such a way that the vertical movement produced by moveable member is converted into a horizontal movement thereby enabling the latches to lock or unlock the release gate.

In an embodiment, the said moveable member is the cylindrical rod (2).

In another embodiment, as the said cylinder rod (2) moves along its central axis, the axial movement is transformed into horizontal movement by the central pivotal arm (14) and yoke left hand thread (7) by pivoting along their respective pivot joints which is further transferred to the yoke (10) by the side link (8) and thread rod (9) thus locking and unlocking the tailgate.

In yet another embodiment, said centre link is for separating the pair of latches.

In another embodiment, said centre link coverts the vertical motion of the cylinder rod to horizontal movement.

In another embodiment, said vertical motion of the cylindrical rod is controlled pneumatically.

In another embodiment, said vertical motion of the cylindrical rod is controlled hydraulically.

In another embodiment, said system for operating the tailgate is adjustable to accommodate various sizes and shapes.

In an embodiment, said locking and unlocking system are not visible from the inside of the dump box or garbage truck.

The present invention also provides an apparatus for operating the door locking and unlocking mechanism in a vehicle or box, said apparatus comprising a pair of latches extending towards opposite sides, a central assembly plate (13) and an external assembly plate (16); said central assembly plate (13) is having a central latch stopper (18) and a central pivotal arm (14) attached; said central assembly plate (13) is further attached to a cylinder alignment plate (15) by means of a cylindrical rod (2) in a cylindrical casing (3) having a clevis pin (4) in the cylindrical bracket (5); said external assembly plate (16) is having an external latch stopper (17) along with a locking jaw (11) and a retaining washer (12), wherein said central plate (13) and external plate (16) are connected by means of a side link (8) having a threaded rod (9) and a yoke (10); the said pair of latches being operable simultaneously in horizontal direction and the entire system being operated in such a way that the vertical movement produced by moveable member is converted into a horizontal movement thereby enabling the latches to lock or unlock the release gate.

In an embodiment, said moveable member is a cylindrical rod that generates to and fro movements.

In another preferred embodiment, said to and fro movements are generated pneumatically or hydraulically.

What is claimed is:

1. A system for operating the door locking and unlocking mechanism in a vehicle or box, said system comprising a pair of latches extending towards opposite sides, a central assembly plate (13) and an external assembly plate (16); said central assembly plate (13) is having a central latch stopper (18) and a central pivotal arm (14) attached; said central assembly plate (13) is further attached to a cylinder alignment plate (15) by means of a cylindrical rod (2) in a cylindrical casing (3) having a clevis pin (4) in the cylindrical bracket (5); said external assembly plate (16) is having an external latch stopper (17) along with a locking jaw (11) and a retaining washer (12), wherein said central plate (13) and external plate (16) are connected by means of a side link (8) having a threaded rod (9) and a yoke (10); the said pair of latches being operable simultaneously in horizontal direction and the entire system being operated in such a way that the vertical movement produced by moveable member is converted into a horizontal movement thereby enabling the latches to lock or unlock the release gate.

2. The system as claimed in claim 1, wherein said moveable member is the cylindrical rod (2).

3. The system as claimed in claim 1, wherein as the said cylinder rod (2) moves along its central axis, the axial movement is transformed into horizontal movement by the central pivotal arm (14) and yoke left hand thread (7) by pivoting along their respective pivot joints which is further transferred to the yoke (10) by the side link (8) and thread rod (9) thus locking and unlocking the tailgate.

4. The system as claimed in claim 1, wherein said centre link is for separating the pair of latches.

5. The system as claimed in claim 3, wherein said centre link converts the vertical motion of the cylinder rod to horizontal movement.

6. The system as claimed in claim 4, wherein said vertical motion of the cylindrical rod is controlled pneumatically.

7. The system as claimed in claim 4, wherein said vertical motion of the cylindrical rod is controlled hydraulically.

8. The system as claimed in claim 1, wherein said system for operating the tailgate is adjustable to accommodate various sizes and shapes.

9. The system as claimed in claim 1, wherein said locking and unlocking system are not visible from the inside of the dump box or garbage truck.

10. An apparatus for operating the door locking and unlocking mechanism in a vehicle or box, said apparatus comprising a pair of latches extending towards opposite sides, a central assembly plate (13) and an external assembly plate (16);
said central assembly plate (13) is having a central latch stopper (18) and a central pivotal arm (14) attached; said central assembly plate (13) is further attached to a cylinder alignment plate (15) by means of a cylindrical rod (2) in a cylindrical casing (3) having a clevis pin (4) in the cylindrical bracket (5); said external assembly plate (16) is having an external latch stopper (17) along with a locking jaw (11) and a retaining washer (12), wherein said central plate (13) and external plate (16) are connected by means of a side link (8) having a threaded rod (9) and a yoke (10); the said pair of latches being operable simultaneously in horizontal direction and the entire system being operated in such a way that the vertical movement produced by moveable member is converted into a horizontal movement thereby enabling the latches to lock or unlock the release gate.

11. The apparatus as claimed in claim 10, wherein said moveable member is a cylindrical rod that generates to and fro movements.

12. The apparatus as claimed in claim 11, wherein the said to and fro movements are generated pneumatically or hydraulically.
